(19) United States
(12) Patent Application Publication
(10) Pub. No.: US 2008/0192025 A1
(43) Pub. Date: Aug. 14, 2008

(54) Touch input devices for display/sensor screen

(76) Inventors: Denny Jaeger, Oakland, CA (US); Andrew Lohbihler, Waterloo (CA)

Correspondence Address: ZIMMERMAN & CRONEN, LLP, 1330 BROADWAY, SUITE 710, OAKLAND, CA, 94612-2506, US

(21) Appl. No.: 12/069,762

(22) Filed: Feb. 12, 2008

Related U.S. Application Data
(60) Provisional application No. 60/901,478, filed on Feb. 13, 2007.

(51) Int. Cl. G06F 3/041

(52) U.S. Cl. 345/173

(57) ABSTRACT

A method and apparatus used in conjunction with a combined display/sensing screen (DSS) includes a transparent outer layer overtop of the sensing screen. A plurality of IR emitters inject IR light edgewise into the outer layer, where it undergoes total internal reflection. Touch input devices have reflective pads on them with a high index of refraction which alters the critical angle in the contact area so that some of the IR is refracted out of the surface and then reflected back through the outer layer to the DSS, where the IR sensor array will detect the position of the reflected light and register a signal. The sensor array signals may be combined into a sensor image to detect touch input devices and movement thereof.

### CROSS-REFERENCE TO RELATED APPLICATIONS

This utility application claims the priority benefit of the filing date of related Prov. Appl. 60/901,478, filed Feb. 13, 2007.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to touch screens that are associated with electronic displays and, more particularly, to arrangements for sensing touch inputs using IR light.

2. Description of Related Art

Display screen technology has advanced to the point where sensor elements may be dispersed or distributed among the picture elements that comprise an electronic display. One such system is described in Publication US2006/0007222, dated Jan. 12, 2006 in which the pixel elements are interspersed with photosensor elements, whereby the display may output an image while also receiving an image through the photosensor elements. Likewise, Publication US2006/0097991 of May 11, 2005 describes an electronic display in which capacitive touch sensing nodes are interspersed with the pixels. In the latter case the stimulation of the sensor inputs may be used to detect one or more touches on the screen. Publication US 2006/0256090 details mechanical overlays that may be used to make touch inputs to the capacitive sensors. However, there appears to be no prior art system in which touch input devices are designed to be used with a display assembly that includes pixel elements interspersed with photosensor elements.

### BRIEF SUMMARY OF THE INVENTION

The present invention comprises apparatus used in conjunction with a combined screen used for display and sensing of movement caused by finger touch or a stylus positioned on an acrylic layer overtop of the sensing screen. The screen has a combination of pixels dedicated for display of the usual RGB or monochrome outputs, as well as embedded sensors substantially equal to the size of the display pixels themselves. In general, this screen assembly serves as a combination sensor and display, and will be referred to herein as the display/sensor screen, or DSS.

In the present invention, the sensor function of the DSS is tuned to receive IR, which is also termed actinic light herein. A transparent outer layer overlies the pixed/display plane, and a plurality of IR emitters (typically in the near-IR band of 0.8-2.0 nm) inject IR light into the outer layer. The IR light is conducted from the perimeter source(s) through the outer layer, and undergoes total internal reflection because the incident angle is less than the critical angle for the outer layer. However, if a human hand or other reflective surface is placed on the outer surface the critical angle is altered and some of the IR is refracted out of the surface being touched and then reflected back through the outer layer to the DSS, where the IR sensor array will detect the position of the reflected light and register a signal. The sensor array signals may be combined into a sensor image.

One embodiment of the invention uses touch input devices that have reflective pads on them to further enhance the optical signal reflected back to the IR sensor array in the DSS. It is significant to note that a plurality of reflective pads can be used, and the multiple touches of the pads may be detected simultaneously, and patterns of touch points may be detected and recognized. Each pattern may be linked to a particular type of input device and allow real-time usage of that device to operate on the DSS by detecting and analyzing changes in the touch points pattern as the control devices are moved and changed by a user.

Each pad has a limited surface area to receive a proportion of IR from the internally reflected IR inside the outer layer situated atop the DSS. The reflective pad reflects this IR toward the DSS sensor array, and the reflected IR is more concentrated and more intense than ambient light or light leaking from the outer layer's surface toward the DSS sensor array. This is due to the construction of the reflective pad, which incorporates a reflective/opaque material that refracts light at larger angles than the light reflected inside the acrylic glass. The opaqueness of the material is determined by the crystal microstructure causing the material to “glow” in the IR sense. One material that has this high angle of reflectivity is TiO₂ (titanium dioxide), and other choices are possible, such as nanoparticles sized and shaped to carry out the reflective function at the desired IR wavelength.

IR light received by the DSS is directed toward the sensors embedded in the DSS. These sensors may be tuned at exactly the same frequency as the emitted IR on the sides of the DSS, if necessary. If it is necessary to provide greater discrimination of the reflected signal from background noise, the emitter can emit IR modulated at a frequency, and the sensor system may be driven to output its signal at the same frequency, to further reject interference.

The DSS may also include a filtering layer under the outer layer for the purpose of further filtering IR reflections and removing the effects of light entering the system from other external sources, or from IR reflections close to but not touching the DSS. These sources are filtered by the filtering layer, since these sources would be converted to diffuse light and not be strong enough to be sensed by the sensor array. The only IR light allowed to pass by the filtering layer is from reflections that are from objects physically touching the acrylic layer. That is, the IR sensor array will only receive IR light that passes substantially vertically through the opaque layer to the sensors.

The invention provides embodiments that emulate the form and function of prior art mechanical input devices, such as knobs, faders, joysticks, touch switches, throw switches, pushbutton switches, and the like. In general, the devices will be independently detected by the sensor array in the DSS and processed in real-time to detect the position and identity of the unique reflective pad configuration (the “footprint” of the device). A plurality of devices may be operated and detected simultaneously.

The knob device operates by incorporating specially shaped reflective pads on the bottom of the device body, facing the DSS. The pattern of the knob reflectors is significant in determining important factors concerning the knob. These factors include:

1) the knob center position;

2) the knob orientation relative to the center location;

3) initial position and orientation without movement.

For these determinations, the knob may be provided with reflectors added to the underside of the device body with identifiable characteristics. For example, the reflector is shaped as an arc having some radial depth and angular width, so that when the DSS sensor array resolves an arc the software recognition algorithms can resolve the center position of the arc and also determine the arc angle with respect to the center position. Recognition algorithms can interpret the circular pattern and identify that a knob is being sensed, and again determine the center as well as the orientation of the turnable cap of the knob. The success of detection and knob interaction depends on the resolution of shape detection and the accuracy of positioning the reflective point on the DSS. An algorithm for detecting the knob position and orientation can self-start with the detected positions of the reflector pad configurations.

The fader device operates by having three reflective pads that are spatially distributed in a predetermined pattern. There are two reflective pads are fixed at the ends of the fader track, and the rectangular shape of the pads and their spacing help determine the identification and orientation of the fader. The third reflective pad is mounted on the bottom of a fader cap that is slidable along the fader track, and its position determines the fader setting with respect to the two fixed reflective pads. An algorithm for detecting the fader position, orientation, and cap position can self-start upon receiving the detected positional inputs of the three reflective pads.

The joystick device operates by having five spatially distributed reflective pads disposed on the bottom of the joystick body. There are four reflective pads that are fixed at the ends of the joystick bottom surface and resemble a diamond shape. The shape of the pads helps determine the orientation of the joystick's diamond pad layout. The fifth reflective pad is movable and connected to the bottom end of a joystick post that has an ergonomic top end to engage the finger(s) or hand of a user. The position of the fifth reflective pad is detected to determine the joystick position. An algorithm for detecting the joystick base position, orientation, and post position may self-start upon receiving the detected positions of the five reflective pads.

The tact-switch device operates by having only one or two concentric reflective pads on the bottom of the switch body, and the circular shapes are identifiable by the sensor system. Pushing the tact switch stem causes the empty outer annular reflective pad to be filled by the central reflective pad, an event that is easily detected by the sensor software system. Throw switches are provided with a similar mechanism but a differing reflective pad pattern for easy identification.

### BRIEF DESCRIPTION OF THE DRAWING

FIG. 1 is a perspective representation of the various embodiments of the invention in use on a display/sensor screen assembly.

FIG. 2 is a schematic view of a generalized embodiment of the invention used in combination with a display/sensor screen assembly.

FIG. 3 is a functional block diagram depicting the steps required to identify the various embodiments of the invention and correlate their position and movement with the screen display of a display/screen assembly.

FIGS. 4A and 4B are schematic bottom views of two embodiments of knob input devices in accordance with the invention.

FIG. 5A is a schematic bottom view of a fader embodiment of the invention, and FIG. 5B is a cross-sectional elevation taken along line 5B-5B of FIG. 5A.

FIG. 6A is a schematic bottom view of a joystick embodiment of the invention, and FIG. 6B is a cross-sectional elevation taken along line 6B-6B of FIG. 6A.

FIGS. 7A and 7B are schematic bottom views of two embodiments of switches of the invention, and FIG. 7C is an elevation depicting a retractable switch of the invention.

FIGS. 8A and 8B are schematic bottom views of further embodiments of switches of the invention and FIG. 8C is an elevation depicting a further switch of the invention.

### DETAILED DESCRIPTION OF THE INVENTION

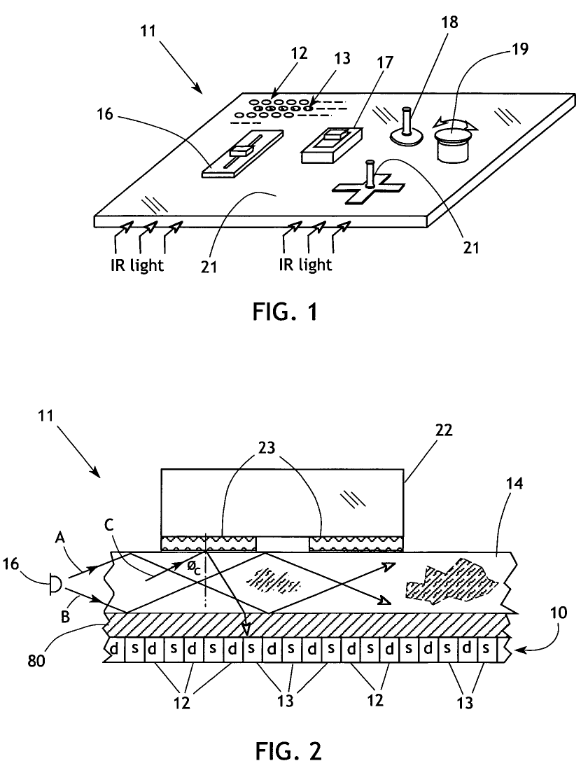

The present invention comprises apparatus used in conjunction with a combined screen 11 used for display and sensing of movement caused by finger touch or a stylus positioned on an acrylic layer overtop of the sensing screen. As shown in FIGS. 1 and 2, the screen has a combination of a plurality of pixels (d) 12 dedicated for display of the usual RGB color outputs, as well as a plurality of embedded sensors (s) 13 intermingled with the pixels 12 in a common stratum or layer 10. Although the drawing shows the two components 12 and 13 in alternating rows, it may be appreciated that there are many distribution pattern or array that may be used to accomplish the functions described below. The pixels 12 may be addressed in any manner known in the prior art, such as raster scanning or line scanning, to generate modulated light in their respective colors and combine to form an image display. Likewise, the sensors may be addressed in any manner known in the art to access the individual sensor signals that indicate the intensity of IR light falling on each sensor, and thus assemble the sensor signals to form, in effect, a sensor image of the IR light incident on the display/sensor screen. This sensor image may have a frame rate similar to the pixel array 12. In general, this screen assembly 11 serves as a combination sensor and display, and will be referred to herein as the display/sensor screen, or DSS 11.

The DSS 11 is provided with an outer layer 14 formed of a highly transparent and durable material, such as glass, acrylic or other polymers, and the like. A plurality of IR emitters 16 (LEDs or the like) are coupled to the edge of the layer 14, so that the IR light is injected into the layer 14 for conduction in the X-Y plane of the layer 14. More particularly, the IR emitters 16 generate light, preferably in the near-IR band of 0.8-2.0 nm, and are arranged to guide the light into the layer 14 at a sub-critical angle. Thus the light is captured within the layer 14, as suggested by rays A and B in FIG. 2, undergoing internal reflections repeatedly in the X-Y plane between the upper and lower surfaces of the layer 14. The critical angle φ is found from the relationship sin φ=n′/n, where n=index of refraction of layer 14 and n′=index of refraction of air=1.

Due to the total internal reflection arrangement, very little of the IR light from emitters 16 is received by the sensors 13 when the outer surface of layer 14 is free of contact with any objects. However, if a human hand or other reflective surface is placed on the outer surface of layer 14 the critical angle is altered and some of the IR is refracted out of the surface being touched and then reflected back through the outer layer to impinge at a greater than critical angle, whereby the light passes through the inner surface of layer 14 to the DSS. The IR sensor array 13 detects the position of the reflected light and registers a signal.

The invention provides a variety of input devices that may be placed on the outer surface of layer 14 to alter the critical angle at that surface and selectively and predictably reflect light into the sensor array 13. As shown in FIG. 1, the invention includes a fader controller 16, a throw switch 17, a tact switch 18, a rotatable knob controller 19, and a joystick 21. The recognition and operation of these devices will be described in more detail below. In general, a user may place one or more of these devices on the DSS 11 (on the outer surface of layer 14), and the system software of the computer system running the DSS will recognize the devices and detect any changes in the position of their respective moving elements, whereby a control variable input may be made to the system by a user. These devices are all removable and replaceable, and are simple, lightweight, and inexpensive. It is noted that these devices all perform complex user input functions without requiring any internal electronics or power supplies. Nor do these devices require placement in any particular orientation or on any particular portion of the DSS 11.

As shown in FIG. 2, an input device of the invention, here depicted as a generalized device 22, has one or more reflective pads 23 on the bottom of the device 22 and disposed to contact the outer surface of layer 14. Each pad 23 incorporates a reflective/opaque material that refracts light at larger angles than the light reflected inside the acrylic layer 14. The opaqueness of the material is determined by the crystal microstructure causing the material to “glow” in the IR sense. It is known from Snell's Law that the critical angle φ_{c} (calculated from a normal to the reflective interface) is found from the relationship sin φ_{c}=n′/n, where n=index of refraction of layer 14 and n′=index of refraction of air=1. The pads 23 are provided with a material that affects the critical angle by raising the index of refraction of the material contacting the layer 14. For example, the pads may contain or be doped with TiO₂ (titanium dioxide), which has an index of refraction that is significantly greater than air, so that the critical angle is greatly increased at the location of the pad 23 and IR light is reflected therefrom to the sensors in that location. This is suggested by ray C in FIG. 2, which is parallel to ray A but is not subject to total internal reflection because it is incident on the contact area of one of the reflective pads 23. The pad 23 allows ray C to refract through the outer surface of layer 14, reflect off the pad 23 and transit through the layer 14 to strike the display/sensor arrays 12 and 13. Other material choices for pads 23 are possible, such as nanoparticles of appropriate size, shape and material to carry out the reflective function at the desired IR wavelength.

The sensors 13 may be tuned at exactly the same frequency as the emitted IR on the sides of the DSS if necessary for signal discrimination. If it is necessary to provide greater discrimination of the reflected signal from background noise, the emitters 16 may be modulated at a frequency that is band-passed by the sensor detection arrangement, in reliance on the fact that random IR noise is not likely to be modulated at the same frequency or phase as the IR emitters 16. Also, the brightness of the IR emitters may be varied to obtain the optimal sensitivity to the pads 23.

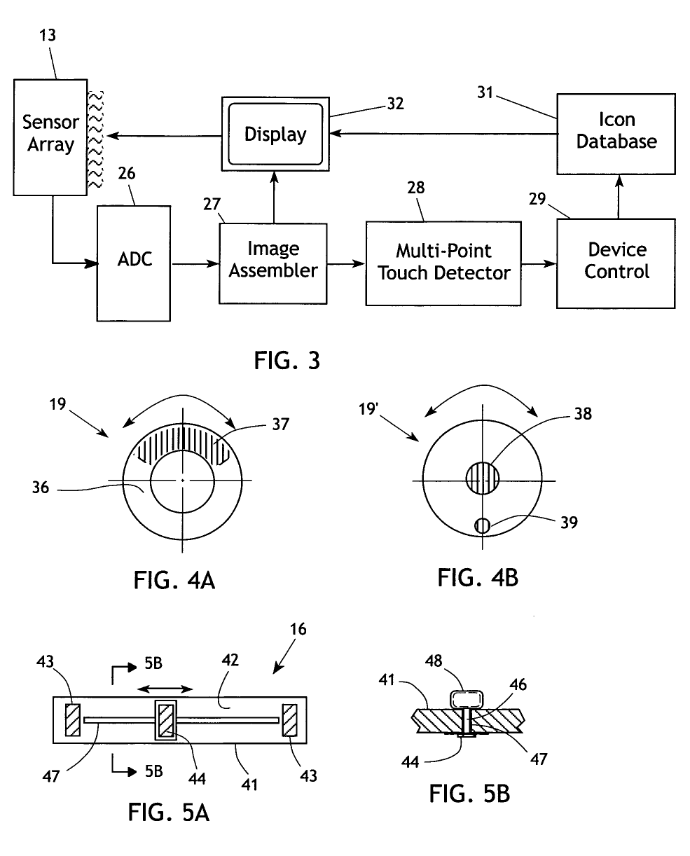

Each touch input device is provided with a unique pattern of reflective pads 23 on its respective bottom surface. With regard to FIG. 3, the computer system that runs the DSS 11 receives the signals from the sensor array 13 and sends them through an analog/digital converter 26. The digitized signals are fed to an image assembler 27 to generate a sensor image. The sensor image is fed to display 32, which includes the pixel emitters 12 described previously. The sensor image is also fed to a multi-point touch detector 28 that detects and defines areas in the sensor image that comport with the size, placement and pattern of the reflective pads 23. A simple pattern matching algorithm yields the type and placement of any of the input devices of FIG. 1. The output is fed to device control unit 29 that determines changes in movable input setting components of the touch input devices, and feeds those changes through an icon database 31 to the display 32. Thus the sensor image and the device control signals are both fed to the display to be presented in an integrated fashion. Each device control signal may be correlated with a respective signal input to the system (such as audio or video signals) to enable the user to vary the signal by use of the touch input device. The device control signals may also be used to vary the size, or magnitude, or position of an onscreen object or other variable scalar or vector.

With regard to FIG. 4A, one embodiment of the knob input device 19 provides on the bottom surface 36 of the device a reflective pad 37 that is shaped as a section of a circular arc. The pad 37 is supported on the turnable portion of the knob controller 17, while the center section 38 is immobile and removably secured to the DSS 11. The sensor processing arrangement of FIG. 3 can identify the arc, and resolve the center position of the arc as well as the total arc angle. Thus the knob controller may be identified easily. Once identified, a subroutine is self-started to monitor the knob controller 19. If subsequent sensor images indicate that the reflective pad 37 has moved about the center position, the software relates the angular movement that is detected to a change in variable assigned to the controller, and the computer system may then enter that change in the assigned variable.

With regard to FIG. 4B, another embodiment of the knob controller 19′ includes a circular reflective pad 38 supported on the bottom surface of a central post, and another circular reflective pad 39 supported on the bottom surface of the turnable outer portion of the knob controller. There is a notable difference in the diameters of the pads 38 and 39, and the sensor processing arrangement of FIG. 3 can identify the two pads and distinguish them by size. Once identified, a subroutine is self-started to monitor the knob controller 19′. As before, the software relates the angular movement of pad 39 that is detected to a change in variable assigned to the controller, and the computer system may then enter that change in the assigned variable.

With regard to FIGS. 5A and 5B, the fader 16 may be comprised of a longitudinally extending body 41 having a bottom surface 42 that presents three reflective pads: a pair of rectangular reflective pads 43 at opposed ends of the body 41, and a similar rectangular reflective pad 44 disposed between the pair 43. The reflective pad 44 is secured to a movable post 46 that extends through a longitudinal slot 47 to join a finger touchpad 48. Thus a finger push on the pad 48 may translate the reflective pad 44 along the slot 47, changing its spacing with respect to the pads 43. The sensor processing arrangement of FIG. 3 can identify the rectangular reflective pads 43 and their unique spacing. Thus the knob controller may be identified easily. Once identified, a subroutine is self-started to monitor the position of reflective pad 44. If subsequent sensor images indicate that the reflective pad 44 has moved with respect to the pair of pads 43, the software relates the linear movement that is detected to a change in variable assigned to the controller, and the computer system may then enter that change in the assigned variable.

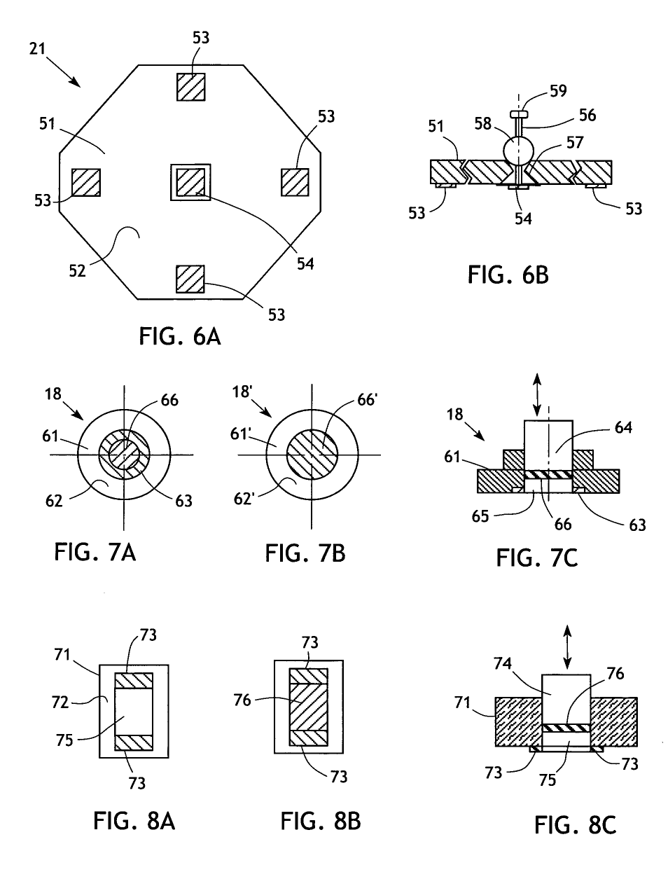

With regard to FIGS. 6A and 6B, the joystick controller 21 of FIG. 1 may be comprised of a base panel 51 configured as a cross (in FIG. 1) or as a polygon as shown in FIG. 6A. On the bottom surface 52 of the panel 51 four rectangular reflective pads 53 are arrayed in spaced apart manner and positioned to define the vertices of an imaginary rectangle. A fifth reflective pad 54 is located approximately in the center of the rectangular array of pads 53. The pad 54 is mounted on the inner end of a movable post 56 that extends through a tapered bore 57 in the panel 51 and through a bearing ball 58 to join a finger touchpad 59. A finger push on the pad 59 may deflect the post 56 in any direction, which will rotate the bearing ball pivot and move the reflective pad 54 accordingly, changing its location with respect to the pads 53. The sensor processing arrangement of FIG. 3 can identify the rectangular reflective pads 53 and their unique rectangular array. Thus the joystick controller may be identified easily. Once identified, a subroutine is self-started to monitor the position of reflective pad 54. If subsequent sensor images indicate that the reflective pad 54 has moved with respect to the quartet of pads 53, the software relates the movement in any direction that is detected to a change in variable assigned to the controller, and the computer system may then enter that change in the assigned variable.

With reference to FIGS. 7A and 7C, the tact switch 18 of FIG. 1 may be comprised of a disc-like body 61 formed of a resilient, form-retaining but deformable material such as soft rubber or plastic. The bottom surface 62 includes an annular reflective pad 63 in approximately the center of the bottom surface. A bore 65 extends inwardly from the bottom surface 62 concentrically with the pad 63, and a plunger 64 in bore 65 includes a lower end supporting a circular reflective pad 66. The plunger may be integrally formed with the body, so that fingertip pressure on the top of the plunger 64 will deflect the plunger resiliently downwardly until the pad 66 impinges on the outer surface of layer 14, and the pads 63 and 66 combine to create a filled annulus. The sensor processing arrangement of FIG. 3 can identify the annular reflective pads 63 and their unique empty circular central area. Thus the tact switch controller may be identified easily by the system. Once identified, a subroutine is self-started to monitor the position of reflective pad 66. If subsequent sensor images indicate that empty annulus is filled, this is an indication that the plunger has been pushed and the reflective pad 66 has been moved to the surface. The software relates this occurrence to a change in variable assigned to the tact switch controller, and the computer system may then enter that change in the assigned variable.

An alternative embodiment 18′ of the tact switch, shown in FIG. 7B, provides a single reflective pad 66′ in the center of the bottom surface 62′. In this case the solid circular reflector is normally in contact with the outer surface of layer 14 and actuated to raise the reflective pad 66′ and interrupt the solid circular reflective image. This can be accomplished, for example, by a snap-acting overcenter diaphragm that may be integrally formed in the body 61′. The sensor system may identify the solid circular reflective pad 66′ and then monitor its continued presence or interrupted presence to detect a switch actuation event and take appropriate action.

With reference to FIGS. 8A-8C, the throw switch controller 17 may be comprised of a rectangular body 71 having a bottom surface 72 that presents two rectangular reflective pads 73 in spaced apart, parallel opposition. A bore 75 extends inwardly from the bottom surface 72 between the two pads 73, and a plunger 74 in bore 75 includes a lower end supporting a rectangular reflective pad 76. The plunger may be integrally formed with the body, so that fingertip pressure on the top of the plunger 74 will deflect the plunger resiliently downwardly until the pad 76 impinges on the outer surface of layer 14, and the pads 73 and 76 combine to create a filled rectangle, as shown in FIG. 8B. The sensor processing arrangement of FIG. 3 can identify the rectangular, closely spaced reflective pads 73 and their unique empty rectangular central area. Thus the throw switch controller may be identified easily by the system. Once identified, a subroutine is self-started to monitor the position of reflective pad 76. If subsequent sensor images indicate that empty rectangle is filled (FIG. 8B), this is an indication that the plunger has been pushed and the reflective pad 76 has been moved to the surface. The software relates this occurrence to a change in the variable assigned to the throw switch controller, and the computer system may then enter that change in the assigned variable.

In all the embodiments described herein, it is assumed that the components will be fabricated of transparent plastic or resin, whereby visualization of the display will be disturbed to a minimal extent by the control devices. Also, the controllers may incorporate a releasable, self-stick adhesive to secure the controller to the outer surface of layer 14. In all descriptions, the reflective pads are assumed to incorporate a material that exhibits a high index if refraction sufficient to liberate IR light from the layer 14 and then reflect it back through the layer 14 to the sensor array. Note also that the system described herein is capable of detecting and tracking a plurality of the touch input devices, and to respond to user changes in their settings in real time (no perceptible delay between user movement and machine response). The system also responds immediately to the placement and removal of the touch input devices on the DSS, enabling rapid setup and alteration of onscreen layouts that employ the touch input devices.

The DSS 11 may also include an filtering layer 80 (FIG. 2) interposed between the outer layer 14 and image/sensor layer 12 and 13 for the purpose of further filtering IR reflections and removing the effects of light entering the system from other external sources, or from specular IR reflections close to but not touching the DSS. These sources are filtered by the layer 80, which is at least partly opaque to IR, since these sources would be converted to diffuse light and not be strong enough to be sensed by the sensor array. The only IR light allowed to pass by the opaque layer is from reflections that are from objects physically touching the outer surface of acrylic layer 14. That is, the IR sensor array will only receive IR light that passes substantially vertically through the opaque layer to the sensors.

Thus the invention provides a wide array of touch input devices that may be used with a DSS that outputs an electronic display image and receives IR sensor inputs in an image sensing array. These devices are all removable and replaceable, and are simple, lightweight, and inexpensive. It is noted that these devices all perform complex user input functions without requiring any internal electronics or power supplies. Nor do these devices require placement in any particular orientation or on any particular portion of the DSS 11.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A mechanical touch input system for use with a display/sensor screen (DSS) assembly having a display output and a photosensor array, including:
an outer transparent layer on said display output;
means for injecting actinic light into said outer layer at an angle to cause total internal reflection in said outer layer, said actinic light propagating along the plane of said outer layer;
at least one mechanical touch input device adapted to be removably secured to the outer surface of said outer layer;
said mechanical touch input device including at least one reflective pad disposed to contact said outer surface of said outer layer;
said reflective pad including a high index of refraction at the wavelength of said actinic light, whereby said outer surface of said outer layer is made conductive to said actinic light at the location of said reflective pad, which reflects said actinic light into impingement with said photosensor array of said DSS;
said at least one reflective pad including a recognizable distinguishing feature;
signal processing means connected to said photosensor array to recognize said recognizable distinguishing feature and identify the respective mechanical touch input device.

2. The mechanical touch input system of claim 1, wherein said at least one touch input device is one of the following categories: fader controller, knob controller, joystick, tact switch and throw switch; and wherein said distinguishing feature comprises each of said categories provided with a respective unique pattern of said at least one reflective pad, whereby each touch input device may be categorically identified by said signal processing means.

3. The mechanical touch input system of claim 1, wherein each touch input device further includes at least one movable reflective pad connected to a user-operated movable element, and said signal processing means resolves movement of said movable reflective pad.

4. The mechanical touch input system of claim 3, wherein said signal processing means further correlates said movement of said movable reflective pad with changes in a system variable assigned to the respective touch input device.

5. The mechanical touch input system of claim 1, wherein said recognizable distinguishing feature includes a polygonal shape.

6. The mechanical touch input system of claim 1, wherein said recognizable distinguishing feature includes a plurality of said reflective pads disposed in a unique planar array.

7. The mechanical touch input system of claim 1, wherein said signal processing means includes ADC means for receiving the signals from said sensor array and converting the signals to digital sensor signals.

8. The mechanical touch input system of claim 7, wherein said signal processing means further includes image assembler means for receiving said digital sensor signals and generating an image from said sensor signals.

9. The mechanical touch input system of claim 8, wherein said image of said sensor signals is reiterated at a frame rate substantially similar to the display output.

10. The mechanical touch input system of claim 8, wherein said signal processing means further includes multi-point touch detector means for receiving said image of said sensor signals and identifying simultaneously a plurality of touch points in said image of said sensor signals.

11. The mechanical touch input system of claim 10, wherein said signal processing means further includes device control means for receiving said plurality of touch points and detecting and identifying at least one of said distinguishing feature in said image of said sensor signals.

12. The mechanical touch input system of claim 11, wherein each touch input device further includes at least one movable reflective pad connected to a user-operated movable element, and said device control means resolves movement of said at least one movable reflective pad in said image of said sensor signals.

13. The mechanical touch input system of claim 12, wherein said signal processing means further includes icon database means for associating an iconic representation of said at least one touch input device and transmitting said iconic representation to said display output, and for modifying said iconic representation in correspondence with movement of said at least one movable reflective pad.

14. The mechanical touch input system of claim 7, further including means for modulating said means for injecting actinic light at a predetermined frequency, and modulating said ADC at said predetermined frequency to discriminate against noise at the wavelength of said actinic light.

15. The mechanical touch input system of claim 1, wherein said actinic light is in the infrared wavelength range of 0.8-2.0 nm.

16. A method for mechanical touch input to a display/sensor screen (DSS) assembly having a display output and a photosensor array, including the steps of:
providing an outer transparent layer on said display output;
injecting actinic light into said outer layer at an angle that creates total internal reflection in said outer layer;
providing at least one mechanical touch input device on the outer surface of said outer layer;
providing said at least one mechanical touch input device with a reflective pad having a high index of refraction at the wavelength of said actinic light, whereby said outer surface of said outer layer is made conductive to said actinic light at the location of said reflective pad, which reflects said actinic light into impingement with said photosensor array of said DSS;
providing said at least one reflective pad with a recognizable distinguishing feature;
providing signal processing means connected to said photosensor array to recognize said recognizable distinguishing feature and identify the respective mechanical touch input device.

17. The method for mechanical touch input of claim 16, further including the step of providing a movable reflective pad that is connected to a user-operated movable element of said at least one mechanical touch input device, and operating said signal processing means to resolve movement of said movable reflective pad and correlate said movement with a system variable assigned to the respective touch input device.
